(19) United States
(12) Patent Application Publication
(10) Pub. No.: US 2023/0211774 A1
(43) Pub. Date: Jul. 6, 2023

(54) Method for controlling an automated parking system and automated parking system

(71) Applicant: Continental Automotive Technologies GmbH, Hannover (DE)

(72) Inventors: Klaus Rink, Rodenbach (DE); Ulrich Stählin, Eschborn (DE); Patrick Keck, Darmstadt (DE)

(73) Assignee: Continental Automotive Technologies GmbH, Hannover (DE)

(21) Appl. No.: 18/150,235

(22) Filed: Jan. 5, 2023

(30) Foreign Application Priority Data
Jan. 5, 2022 (DE) 10 2022 200 068.4

(51) Int. Cl. B60W 30/06; B60W 30/095; B60Q 9/00

(52) U.S. Cl. CPC B60W 30/06; B60W 30/095; B60Q 9/008; B60W 2554/4041; B60W 2554/4044

(57) ABSTRACT

A method for controlling an automated parking system including determining a position and route of a vehicle for transmitting driving commands for the route to the vehicle, detecting an object within the parking system, determining the position and a movement path of the object, checking whether the route of the vehicle and the movement path of the object overlap, and initiating at least one measure by the parking system to prevent a collision between the vehicle and the object.

### CROSS-REFERENCE TO RELATED APPLICATIONS

The present application claims priority from German Patent Application No. 10 2022 200 068.4 filed on Jan. 5, 2022, in the German Patent and Trade Mark Office the content of which is here incorporated by reference in its entirety.

### BACKGROUND

### 1. Field

Aspects of embodiments of the present application relate to a method for controlling an automated parking system, wherein the parking system has a transfer region, in which the vehicle is transferred to the parking system, and a parking region, in which the vehicle can be parked, wherein the parking system has a communication device, a controller and at least one sensor for monitoring the parking region, wherein the communication device can set up communication with a vehicle to be parked, and the controller can transmit control commands to the vehicle via the communication device. Aspects of embodiments of the present application furthermore relate to such a parking system.

### 2. Description of Related Art

Automated parking systems in which the vehicle is transferred from the vehicle user to the parking system are known from the prior art. The vehicle is then parked in a parking region of the parking system in an automated manner by the parking system. As soon as the vehicle user wishes to use his vehicle, the vehicle is guided by the parking system to the transfer station and is transferred to the vehicle user at said station.

For example, automatic control of a vehicle, in the context of a driving specification, may be in the form of automated valet parking (AVP) type 2. This is a system in which a vehicle is parked in a parking garage and the occupants can get out. The vehicle is then guided to a free parking space by an automatic controller, which is at least substantially based on an infrastructure and a sensor system installed in the parking garage, and is parked in said parking space. When the occupants return and would like to accept their vehicle again, the vehicle is likewise moved to a transfer space again.

Corresponding systems are currently being developed and standardized, for example in the context of the ISO 23374 standard. In this case, provision is made, in particular, for the vehicle itself to not necessarily need to have environmental sensors in order to participate in the system. Accordingly, the vehicle must be able to rely on the infrastructure, from which it receives driving specifications. If there are also other vehicles or persons in a parking garage, for example, it is important for the automatic control of the vehicle to be very reliable and to also be able to react quickly in the case of unforeseen events, for example triggered by careless persons. In particular, protecting persons (vulnerable road users—VRUs) who may be located in the parking system has high priority.

### SUMMARY

According to an aspect of an embodiment, there is provided a parking system and a method for operating such a parking system, which reliably prevents a collision between a vehicle and an object in the parking system.

In order to achieve the aspect, a method for controlling an automated parking system is provided, wherein the parking system has a transfer region, in which the vehicle is transferred to the parking system, and a parking region, in which the vehicle can be parked, wherein the parking system has a communication device, a controller and at least one sensor for monitoring the parking region, wherein the communication device can set up communication with a vehicle to be parked, and the controller can transmit control commands to the vehicle via the communication device. The following steps are repeatedly carried out:
a) determining the position of the vehicle by means of the at least one sensor, determining a route for the vehicle by means of the controller and transmitting driving commands for the determined route to the vehicle via the communication device,
b) detecting an object within the parking system, the movement path of which cannot be controlled by the parking system, and determining the position and a movement path of the object by means of the at least one sensor and the controller,
c) checking whether the route of the vehicle and the movement path of the object can overlap by means of the controller,
d) if a possible overlap between the route and the movement path has been detected, initiating at least one measure by the parking system that involves interaction with the object and prevents a collision of the vehicle with the object.

In an automated parking system, in particular in an AVP type 2 system, the vehicle is remotely controlled within the parking system by the infrastructure of the parking system. For this purpose, the parking system has a sensor system which can detect the vehicle, its position and its direction of movement. The parking system also has a controller which determines a route within the parking system for the vehicle, for example to a parking space or a transfer station. A connection to the vehicle is set up via a communication device and the vehicle is controlled along the predetermined route to the parking space.

The vehicle is usually controlled using a control loop in which the position and the direction of travel of the vehicle are repeatedly determined in order to adapt or correct the route if necessary.

According to an aspect of an embodiment, the method also comprises detecting objects within the parking system. These objects may be, for example, items which unintentionally entered the parking system, or persons located in the parking system.

The parking system detects these objects and initially determines whether it is an object whose movement path can be controlled, in particular remotely controlled, by the parking system. For this purpose, the parking system can attempt, for example, to set up communication with the object via the communication device. Furthermore, vehicles are usually registered at a transfer station and their path within the parking system is monitored. If an object cannot be assigned to any of the registered vehicles, a different object must be assumed.

The position and a direction of movement of the object are then detected using the sensors of the parking system and a movement path is determined or estimated.

A check is then carried out in order to determine whether there are overlaps between the route of the vehicle and the movement path of the object, in particular whether there is the risk of a collision between the vehicle and the object.

If this is the case, the parking system initiates a measure in order to interact with the object. This interaction is intended to influence the object in such a manner that a collision with the vehicle can be prevented and/or the movement path of the object and the route of the vehicle do not overlap.

A new cycle of the control loop is then carried out, that is to say the position and the direction of travel of the vehicle are determined again and the route is adapted or corrected if necessary and the position and the movement path of the object are detected or estimated. If the subsequent checking of the route and the movement path reveals that they still overlap, the interaction measures are continued or further measures are initiated if necessary.

If the checking reveals that the movement path of the object and the route of the vehicle no longer overlap, the measures are stopped.

Even if the interaction measures are stopped, the movement path of the object is still checked in order to check whether the movement path of the object changes in such a manner that it overlaps the route of the vehicle again.

For example, the interaction may comprise warning the object and/or informing the object that the object is in the route of the vehicle. If the object is a person located in the parking system, this person can be made aware of the vehicle by virtue of the interaction, with the result that the person can take suitable measures to move out of the route of the vehicle.

The interaction may also comprise influencing the movement path of the object, in particular the person. For example, suitable measures, for example a guidance system for persons, can to be used to guide the person in such a manner that the person's movement path does not overlap the route of the vehicle.

The interaction can take place acoustically, for example. For example, the person can be warned by means of acoustic warnings, for example horn signals or alarm signals. Furthermore, it is also possible to output spoken advice, instructions or commands which warn a person or provide specific behavioral advice. In particular, spoken advice has the advantage that the person can be addressed directly, for example in order to point the person to a safe path or to provide the person with behavioral advice relating to how the person can leave the route of the vehicle and/or the parking system.

The interaction can also take place optically, for example by means of light signals, illuminated panels or signs. In particular, appropriate indications, for example arrows, can be used to specify a direction in which the person is intended to move in order to ensure that the person is outside the route of the vehicle. In particular, a movement path can be specified to a person by controlling the light inside the parking system. Language-independent influencing is also possible as a result.

The interaction can optionally take place via communication means, for example by means of advice which is transmitted to a smartphone or another communication device carried by the person. For example, it is possible to check whether messages can be transmitted to a smartphone, for example using WLAN, Bluetooth or another transmission standard. For example, it is also possible to use an app which can or must be used by users to log on to the parking system before they can enter the latter.

Various interaction possibilities can preferably be combined in order to make the person aware in the best possible way that the person is in a route of a vehicle. In particular, the intensity and the number of interactions can also be varied, for example depending on the distance between the vehicle and a person or the person's behavior.

This measure can be carried out by the vehicle itself, for example, in which case the measure is controlled or initiated by the parking system. For example, it is possible to use acoustic or optical devices of the vehicle, for example a horn, headlights, turn signals or lighting devices. As a result, the person can be immediately made aware of the vehicle and its direction of travel, with the result that the person can estimate the route of the vehicle, for example, and can move away from it.

Alternatively or additionally, the interaction may also take place by means of the parking system, for example by means of optical or acoustic devices within the parking system. This may have the advantage that devices in the immediate vicinity of the person are activated in order to make the person aware of the vehicle. Furthermore, devices of the parking system can also be used to influence the movement path of the person, for example by making the person aware of a particular path.

The parking system preferably selects at least one interaction on the basis of the position of the vehicle, the route of the vehicle, the position of the object and/or the movement path of the object.

For example, the type of object can also be detected and the type of interaction takes place on the basis of the type of detected object. If a person is detected, for example, spoken advice or indication arrows can be used to show the person a movement path which does not overlap the route of the vehicle. If an animal is detected, for example, sound or light signals can be used instead in order to chase the animal away from the route of the vehicle.

Furthermore, the parking system can detect whether the object reacts to the measures, and the measures can be adapted according to the reaction of the object. If the object does not react, an employee can be informed, for example, and/or the vehicle is stopped until the object is outside the route of the vehicle.

In addition, the measures and the person's reaction can be recorded and/or documented using cameras which are present in the parking system. For example, it is thus possible to identify a person deliberately interfering with the route of the vehicles. Furthermore, the measures can be documented, for example for subsequent evaluation.

### BRIEF DESCRIPTION OF THE DRAWINGS

Further advantages and features are found in the following description in conjunction with the accompanying drawings, in which:

FIG. 1 shows a schematic illustration of an automated parking system; and

FIG. 2 shows a flowchart of a method for checking a vehicle in the parking system from FIG. 1.

### DETAILED DESCRIPTION

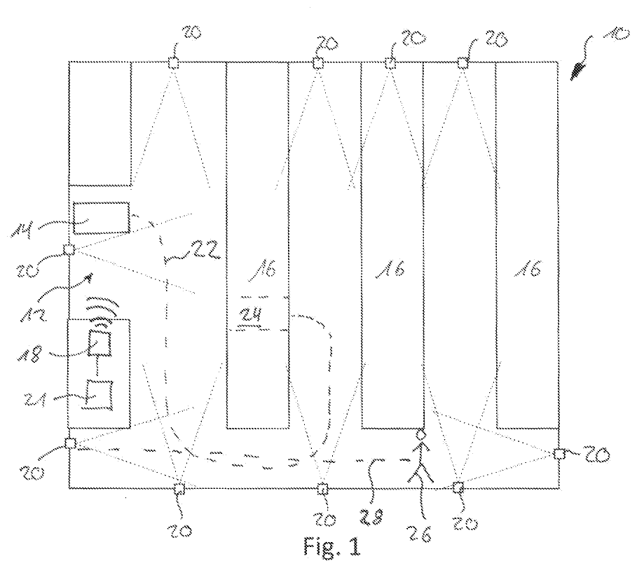

FIG. 1 shows an automated parking system 10. The parking system has a transfer region 12, in which a vehicle 14 can be transferred to the parking system 10, and a parking region 16, in which the vehicle 12 can be parked.

The parking system 10 has a communication device 18 which can set up communication with the vehicle 14. The parking system 10 also has a plurality of sensors 20, which monitor the entire parking region 16, and a control unit 21 which calculates a route 22 for the vehicle 14 from the transfer region 12 to a parking space 24 in the parking region 16 and transmits driving commands to the vehicle 14 so that the vehicle independently drives along the route 22 to the parking space 24.

The vehicle user transfers his vehicle 14 to the parking system 10 in the transfer region 12. The parking system 10 then assumes control of the vehicle 14 and controls it along the route 22 to the parking space 24. If the vehicle user wishes to use his vehicle 14, the control unit 21 calculates a route 22 from the parking space 24 to the transfer region 12. The communication device 18 then transmits corresponding driving commands to the vehicle 14, with the result that the vehicle 14 can be driven to the transfer region by the parking system 10.

After the vehicle 14 has been transferred in the transfer region, the parking system 10 assumes control of the vehicle within the parking system 10 until the vehicle 14 is returned to the vehicle user.

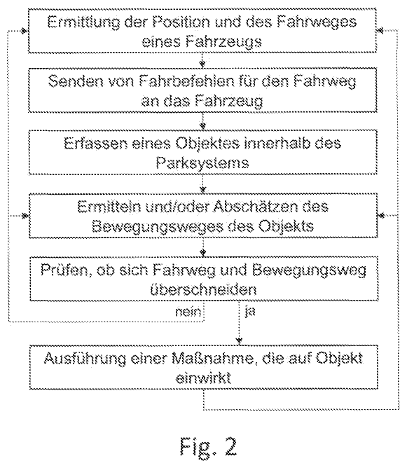

The vehicle 14 is controlled in this case using a control loop in which the position and the direction of travel of the vehicle are repeatedly checked using the sensors 20 of the parking system 10 and the route of the vehicle is adapted or corrected if necessary (see FIG. 2). If there are a plurality of vehicles 14 in the parking system 10, the routes 22 are calculated for these vehicles in such a manner that the routes do not overlap.

In addition to the vehicle 14 or a plurality of vehicles 14, there may also be other objects within the parking system 10, in particular within the parking region 16. For example, persons may enter the parking region 16 without authorization or animals may be located in the parking region 16. Furthermore, other objects may also enter the parking system.

The entire parking system 10, in particular the parking region 16, is captured or monitored by the sensors 20. Since the vehicles present in the parking system were previously registered in the transfer region 12 and their position and direction of movement are known, further objects 26 which have entered the parking system 10 can be identified as foreign objects.

If a foreign object 26 is detected within the parking system 10, in particular within the parking region 16, it is possible to check first of all what type of object is involved. For example, a database and/or a recognition algorithm for various objects 26 may be available to the control unit 21. Furthermore, a check is carried out in order to determine whether and how the object 26 is moving within the parking system, and a likely movement path 28 of the object 26 is possibly calculated and/or estimated.

If a stationary or immovable object 26 is identified, corresponding measures are initiated in order to avoid a collision with the vehicle 14. For example, the vehicle 14 may be braked or the route 22 of the vehicle 14 may be changed. Furthermore, personnel can be informed that the object 26 is moving away.

If a moving object 26, for example an animal or a person, is identified, the position and movement thereof are detected and the likely movement path 28 of the object 26 is calculated and/or estimated.

A check is then carried out in order to determine whether the calculated and/or estimated movement path 28 of the object 26 overlaps the route 22 of the vehicle 14. If the control unit 21 determines a possible overlap of the movement path 28 and the route 22, at least one measure is initiated that is intended to cause the object to leave the route 22 of the vehicle or to change the movement path in such a manner that it does not overlap the route 22 of the vehicle 14.

In this case, the measures are designed to act on the object 26 in order to avoid hindering or delaying the parking process of the vehicle 14 if possible. If there is nevertheless the risk of a collision with the vehicle 14, the vehicle 14 can be braked via the control unit 21 or its route 22 can be changed.

Interaction with the object may comprise acoustic signals, for example, wherein the acoustic signals can be output via loudspeakers in the parking system 10. Alternatively or additionally, it is also possible to use systems of the vehicle 14.

The acoustic signals comprise, for example, warning tones which are used to make the object 26 aware of a risk. These warning tones are preferably output such that the object 26 or the person can identify the direction from which the vehicle is approaching or from which there is a risk of a collision. For example, signals from the vehicle or individual loudspeakers within the parking system 10 can be used for this purpose.

Deliberately controlling individual loudspeakers within the parking system 10 also makes it possible to actively influence the movement path 28 of the object 26, for example. For example, the intensity of a warning tone can increase if the object 26 moves toward the vehicle 14 or the route 22, or can decrease if the object 26 moves away from the vehicle 14 or the route 22. In this case, the volume of the warning tone, its frequency or pitch or a repetition frequency can be changed, for example.

Furthermore, advice or voice commands can also be output via loudspeakers. Warnings may likewise be output via said loudspeakers. However, it is also possible to additionally output instructions, for example which path is intended to be used by a person or how the person is intended to move within the parking system 10.

Alternatively, it is also possible to output optical signals, in which case the systems of the vehicle or systems present in the parking system 10 can also be used here. For example, a guidance system which can specify a movement path to a person may be installed in the parking system 10. Furthermore, paths which are not intended to be used by the person in order to avoid crossing the route of the vehicle may also be indicated using such a guidance system.

If the object 26 is identified as a person, it is also possible to output signals, for example, which can be received via a communication device belonging to the person, for example via a smartphone. For example, signals can be output to the smartphone using Bluetooth, WLAN or another transmission possibility.

In this case, the measures are selected on the basis of the detected object 26, its movement path 28 and possibly further external circumstances, such as brightness, other noise sources or the time of day. For example, light signals can be seen better at night or in the case of low lighting. Furthermore, acoustic signals can be perceived to be disruptive at night outside the parking system.

After carrying out the measures, the movement path 28 of the object 26 is checked and is newly determined or estimated. The measures are continued or stopped or further measures are initiated depending on the newly determined or estimated movement path 28. For example, the measures can be suspended if the object 26 is on a desired movement path which does not overlap the route 22 of the vehicle 14.

Even if the movement path 28 no longer overlaps the route 22 of the vehicle 14, the movement path 28 of the object is still monitored or the likely movement path 28 is determined and/or estimated. As soon as there is an overlap with the route 22 of the vehicle 14 again, corresponding measures for interacting with the object are initiated again.

This process is continued until the object 26 is no longer in the parking system 10, in particular is no longer in the parking region 16.

In addition, the measures and the movement path 28 of the object 26 can be documented by the parking system 10. For example, this information can be evaluated in order to be able to assess the effectiveness of individual measures or to be able to document misbehavior of particular objects, in particular individual persons, and initiate corresponding measures.

1. A method of controlling an automated parking system the method comprising:
determining a position and a route of a vehicle;
detecting an object within the parking system;
determining a position and a movement path of the object;
determining that the route of the vehicle and the movement path of the object will overlap; and
transmitting driving commands by the parking system to the vehicle to prevent a collision between the vehicle and the object.

2. The method according to claim 1, further comprising transmitting a warning to the object by the parking system that indicates the collision between the vehicle and the object.

3. The method according to claim 2, wherein transmitting the warning comprises influencing the movement path of the object.

4. The method according to claim 3, wherein the warning is an acoustic warning.

5. The method according to claim 3, wherein the warning is an optic warning.

6-11. (canceled)
